(19) United States
(12) Patent Application Publication
(10) Pub. No.: US 2009/0086030 A1
(43) Pub. Date: Apr. 2, 2009

(54) CAMERA APPARATUS AND CONTROL METHOD THEREOF

(75) Inventor: Takeshi Takamiya, Iruma-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/199,531

(22) Filed: Aug. 27, 2008

(30) Foreign Application Priority Data
Sep. 28, 2007 (JP) 2007-255027

(51) Int. Cl. H04N 5/225

(52) U.S. Cl. 348/207.1; 348/E05.024

(57) ABSTRACT

According to one embodiment, a camera apparatus includes a storage device and a data transfer module. The storage device is configured to store the image data, an operating system for activating an external apparatus, and a second image edit program configured to run on the operating system. The data transfer module is configured to transfer the operating system to the external apparatus in accordance with a first read request from the external apparatus, and to transfer the second image edit program to the external apparatus in accordance with a second read request, the second read request being sent from the operating system after the operating system is booted on the external apparatus.

### CROSS-REFERENCE TO RELATED APPLICATIONS

This application is based upon and claims the benefit of priority from Japanese Patent Application No. 2007-255027, filed Sep. 28, 2007, the entire contents of which are incorporated herein by reference.

### BACKGROUND

1. Field

One embodiment of the invention relates to a camera apparatus, such as a digital movie camera, and a control method for controlling the operation of the camera apparatus.

2. Description of the Related Art

In these years, various kinds of camera apparatuses, such as digital movie cameras, have been developed. In usual cases, the edit of image data (e.g. moving picture data), which is acquired by the photographing by means of a camera apparatus, is executed by using an external apparatus such as a personal computer. In this case, a user is required to perform, in advance, a work of preparing an application program for image data edit, and installing the application program in the external apparatus such as a personal computer. In addition, in order to actually set the personal computer in an environment in which the edit of image data is executable, the user is required to perform an operation of starting the application program after an operating system of the personal computer is booted, and transferring image data from the camera apparatus to the personal computer.

Thus, a great deal of time is needed until completing the creation of the environment in which the edit of image data, which is acquired by the photographing by the camera apparatus, is enabled with use of the personal computer.

Jpn. Pat. Appln. KOKAI Publication No. 2006-31663 discloses a computer apparatus which is connectable to an audio-video apparatus. In this computer apparatus, in order to quickly start an audio-video function of the computer apparatus, use is made of an operating system which is stored in a non-hard-disk storage medium such as a CD-ROM, aside from the operating system which is pre-installed in a hard disk in the computer apparatus. The non-hard-disk storage medium also stores an audio-video application program. When the computer apparatus is activated, the operating system stored in the non-hard-disk storage medium is booted, and then an audio-video apparatus, which is connected to the computer apparatus, is detected. After a driver program for the detected audio-video apparatus is executed, the audio-video application program that is stored in the non-hard-disk storage medium is executed.

By activating the computer apparatus with use of the non-hard-disk storage medium that stores the operating system and the audio-video application program, it becomes possible to execute the audio-video application program without booting the operating system that is pre-installed in the hard disk of the computer apparatus.

In the technique of Jpn. Pat. Appln. KOKAI Publication No. 2006-31663, however, each time the audio-video function is used, the user has to perform the work of inserting the dedicated non-hard-disk storage medium, which stores the operating system and the audio-video application program, in a disk drive of the computer apparatus, as well as connecting the audio-video apparatus to the computer apparatus.

Jpn. Pat. Appln. KOKAI Publication No. 2007-58701 discloses a recording/playback apparatus including a hard disk. The hard disk of this recording/playback apparatus prestores image processing/editing software which is to be installed in an information processing apparatus at a time of use. When the recording/playback apparatus is connected to the information processing apparatus, a process of installing in the information processing apparatus the image processing/editing software, which is stored in the hard disk of the recording/playback apparatus, is automatically started. Accordingly, the user can install the image processing/editing software in the information processing apparatus, simply by connecting the recording/playback apparatus to the information processing apparatus.

In the technique of Jpn. Pat. Appln. KOKAI Publication No. 2007-58701, however, the process of installing the image processing/editing software is executed by the operating system that is pre-installed in the hard disk of the information processing apparatus. Thus, the process of installing the image processing/editing software cannot be executed until the operating system of the information processing apparatus is booted.

The image processing/editing software is a software which runs on the operating system that is pre-installed in the hard disc of the information processing apparatus. Thus, in order to perform an editing operation, the user has to execute the operation of booting the operating system of the information processing apparatus and then execute the operation of starting the image processing/editing software.

Since the operating system of the information processing apparatus is a general-purpose operating system having various functions, a relatively long time is needed to boot the operating system.

Therefore, it is necessary to realize a novel function for enabling a quick start of edit of image data, which is captured by a camera apparatus, by only a simple operation using an external apparatus, without using a dedicated storage medium.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the structure of a camera apparatus according to an embodiment of the invention;

FIG. 2 is an exemplary block diagram showing the system configurations of the camera apparatus according to the embodiment and an external apparatus which is connected to the camera apparatus;

FIG. 3 is an exemplary view for describing an example of a plurality of memory areas which are allocated to a storage device provided in the camera apparatus according to the embodiment;

FIG. 4 is an exemplary view for describing another example of a plurality of memory areas which are allocated to the storage device provided in the camera apparatus according to the embodiment;

FIG. 5 shows a functional structure of a first image edit program which is stored in the storage device provided in the camera apparatus according to the embodiment;

FIG. 6 shows a functional structure of a second image edit program which is stored in the storage device provided in the camera apparatus according to the embodiment;

FIG. 7 is an exemplary flow chart illustrating the procedure of a data transfer process which is executed by the camera apparatus according to the embodiment;

FIG. 8 is an exemplary flow chart illustrating the procedure of a boot process which is executed by the external apparatus that is connected to the camera apparatus according to the embodiment;

FIG. 9 shows an edit screen which is displayed on a display device of the external apparatus that is connected to the camera apparatus according to the embodiment;

FIG. 10 is an exemplary view for describing the operating of displaying image data, which is edited by the external apparatus that is connected to the camera apparatus according to the embodiment, on the display device of the camera apparatus according to the embodiment; and

FIG. 11 is an exemplary flow chart illustrating the procedure of a simultaneous recording process which is executed by the camera apparatus according to the embodiment.

### DETAILED DESCRIPTION

Various embodiments according to the invention will be described hereinafter with reference to the accompanying drawings. In general, according to one embodiment of the invention, there is provided a camera apparatus including: an edit module configured to execute a first image edit program to edit image data acquired by a camera module within the camera apparatus; a storage device configured to store the image data, an operating system for activating an external apparatus, and a second image edit program configured to run on the operating system; and a data transfer module configured to transfer the operating system to the external apparatus in accordance with a first read request from the external apparatus, and to transfer the second image edit program to the external apparatus in accordance with a second read request, the second read request being sent from the operating system after the operating system is booted on the external apparatus.

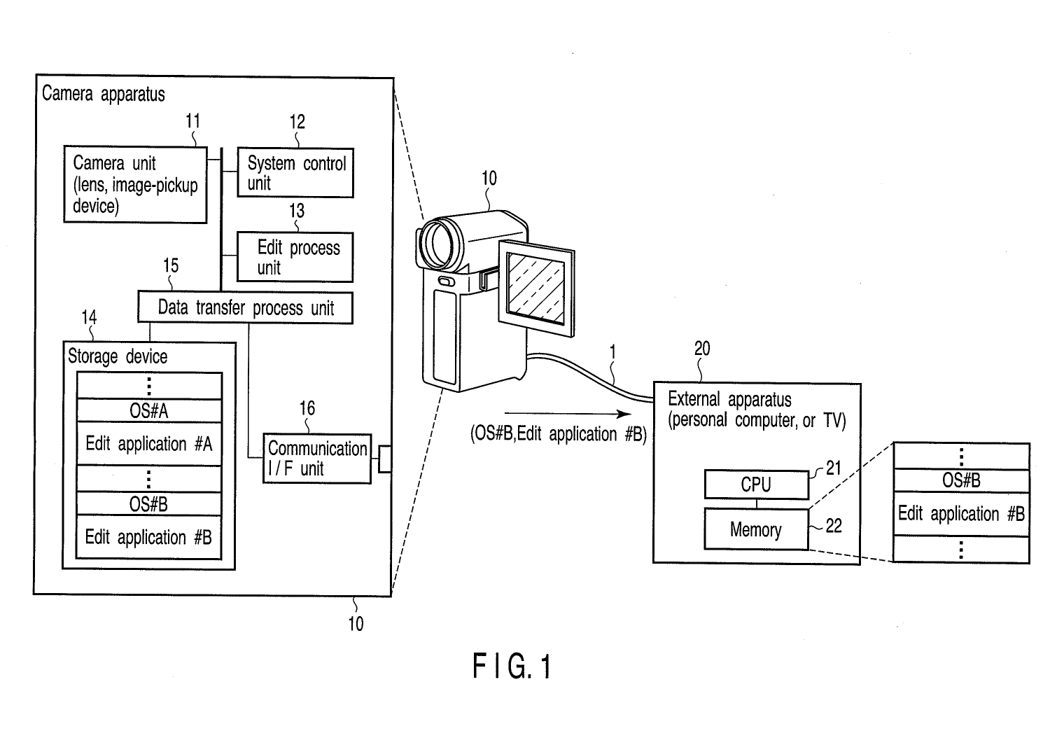

FIG. 1 shows the structure of a camera apparatus according to an embodiment of the present invention. The camera apparatus is realized, for example, as a portable digital movie camera apparatus 10. The camera apparatus 10 incorporates a random-accessible storage device such as a hard disk drive. Image data (moving picture data, still image data) which is acquired by a photographing operation by means of the camera apparatus 10 is stored in the storage device in the camera apparatus 10. In addition, the camera apparatus 10 can execute communication with an external apparatus 20 via a cable 1 such as a USB cable.

The camera apparatus 10 includes a camera unit 11, a system control unit 12, an edit process unit 13, a storage device 14, a data transfer process unit 15 and a communication interface unit 16.

The camera unit 11 is a camera module which is composed of an imaging lens and an imaging element (CCD or CMOS sensor) which functions as a photoelectric conversion unit. The camera unit 11 executes a photographing operation of photoelectrically converting a subject image, thereby generating a video signal corresponding to the subject image. The system control unit 12 is a processor which controls the operation of the camera apparatus 10. The edit process unit 13 is an edit module which edits the image data (i.e. image data stored in the storage device 14) which is acquired by the photographing operation by means of the camera unit 11.

The storage device 14 stores the image data acquired by the photographing operation. The storage device 14 is a random-accessible storage device, and is realized by, for instance, a hard disk drive. The storage device 14 stores a first operating system (OS#A), a first image edit program (edit application #A), a second operating system (OS#B), and a second image edit program (edit application #B).

The first operating system (OS#A) is an operating system for controlling the operation of the camera apparatus 10, and is executed by the system control unit 12. The first image edit program (edit application #A) is an application program for editing the image data (i.e. image data stored in the storage device 14) which is acquired by the photographing operation by means of the camera unit 11, and is configured to run on the first operating system (OS#A). The first image edit program (edit application #A) is executed by the edit process unit 13.

The second operating system (OS#B) is an operating system for activating the external apparatus 20, and is executed by a processor in the external apparatus 20. The second image edit program (edit application #B), like the first image edit program (edit application #A), is an application program for editing the image data which is stored in the storage device 14. The second image edit program (edit application #B), however, is configured to run on the second operating system (OS#B), and is executed by the processor in the external apparatus 20.

An area in which the second operating system (OS#B) and second image edit program (edit application #B) are stored is a system area which is defined in the memory space of the storage device 14.

The first operating system (OS#A) and the first image edit program (edit application #A) may be stored in a nonvolatile memory, such as a flash EEPROM, which is provided in the camera apparatus 10. In other words, it should suffice if the storage device 14 includes at least three memory areas, namely, a first memory area, a second memory area and a third memory area. The first memory area is a memory area (user data area) for storing image data which is acquired by a photographing operation by means of the camera unit 11. The second memory area is a memory area for storing the second operating system (OS#B). The third memory area is a memory area for storing the second image edit program (edit application #B). The second memory area and third memory area are present in the above-described system area in which data write is prohibited.

The data transfer process unit 15 is a data transfer module which executes read/write access to the storage device 14 in accordance with a read/write request which is sent from the system control unit 12, and also executes read/write access to the storage device 14 in accordance with a read/write request which is sent from the external apparatus 20 via the cable 1 and the communication interface unit 16.

If the memory area which is designated by a read request sent from the external apparatus 20 is the area in which the second operating system (OS#B) is stored, the data transfer process unit 15 executes a process of reading out the second operating system (OS#B) from the storage device 14, and transferring the second operating system (OS#B) to the external apparatus 20 via the communication interface unit 16. If the memory area which is designated by a read request sent from the external apparatus 20 is the area in which the second image edit program (edit application #B) is stored, the data transfer process unit 15 executes a process of reading out the second image edit program (edit application #B) from the storage device 14, and transferring the image edit program (edit application #B) to the external apparatus 20 via the communication interface unit 16.

The communication interface unit 16 is a communication module which executes communication with the external apparatus 20 via the cable 1. The communication interface unit 16 is composed of, for instance, a USB controller.

In the state in which the camera apparatus 10 is connected to the external apparatus 20 via the cable 1, the storage device 14 in the camera apparatus 10 functions as an external boot device which is accessible by the external apparatus 20.

The external apparatus 20 is realized, for example, by an information processing apparatus such as a personal computer, or by a TV apparatus. The external apparatus 20 includes a CPU 21 and a memory 22. For example, in the state in which the camera apparatus 10 is connected to the external apparatus 20 via the cable 1, when the external apparatus 20 is powered on, the CPU 21 sends a read request for reading the second operating system (OS#B), which is stored in the system area of the storage device 14, to the camera apparatus 10 via the cable 1. In response to the read request, the second operating system (OS#B) is read out from the system area of the storage device 14 and is loaded in the memory 22 of the external apparatus 20 via the cable 1. Then, the second operating system (OS#B) is booted by the CPU 21. After the second operating system (OS#B) is booted, the second operating system (OS#B) sends a read request for reading the second image edit program (edit application #B), which is stored in the system area of the storage device 14, to the camera apparatus 10 via the cable 1. In response to this read request, the second image edit program (edit application #B) is read out from the system area of the storage device 14 and is loaded in the memory 22 of the external apparatus 20 via the cable 1. Then, the second image edit program (edit application #B) is executed by the CPU 21.

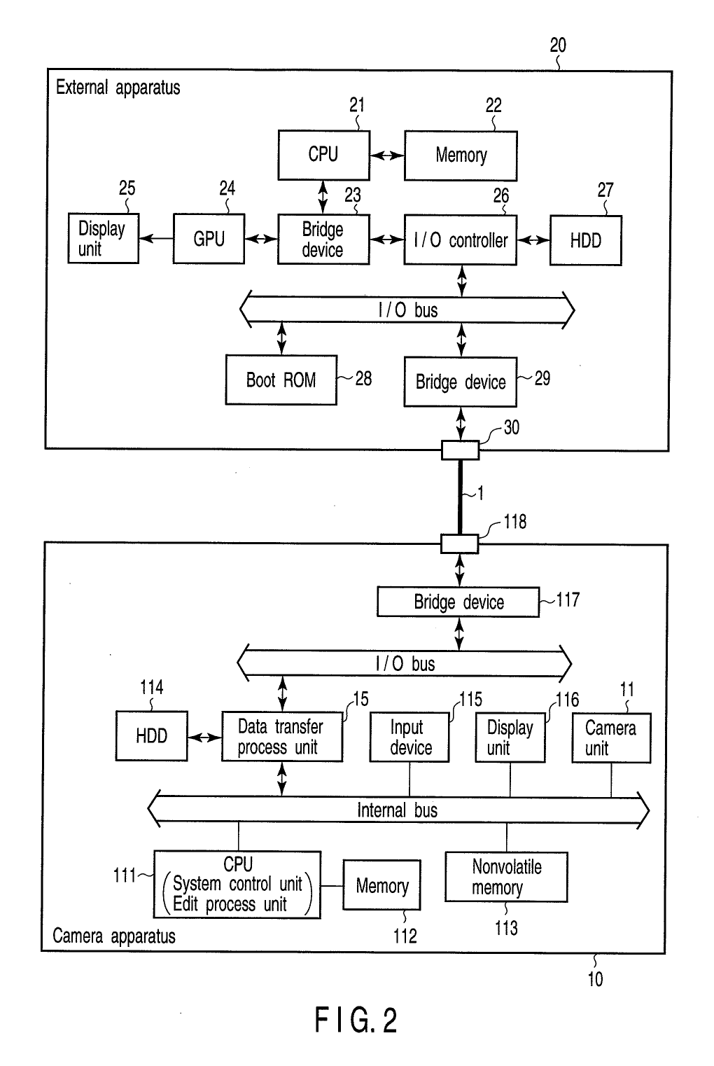

Next, referring to FIG. 2, specific examples of the system configurations of the camera apparatus 10 and the external apparatus 20 are described.

The camera apparatus 10 includes, in addition to the above-described camera unit 11 and data transfer process unit 15, a CPU 111, a main memory 112, a nonvolatile memory 113, a hard disk drive (HDD) 114, an input device 115, a display unit 116 and a bridge device 117.

The CPU 111 is a processor which controls the operation of the camera apparatus 10. The CPU 111 functions as the above-described system control unit 12 and edit process unit 13. The nonvolatile memory 113 stores the first operating system (OS#A) and first image edit program (edit application #A).

The HDD 114 functions as the above-described storage device 14. Under the control of the CPU 111, the data transfer process unit 15 executes, for example, data transfer between an I/O bus and the HDD 114 and data transfer between an internal bus and the HDD 114. The input device 115 is composed of, for instance, various operation buttons and a touch panel. The display unit 116 is, for instance, a finder monitor which is provided on the camera apparatus 10. The bridge device 117 functions as the above-described communication interface unit 16, and executes communication with the external device 20 via the cable 1 that is connected to an I/O connector 118 that is provided on the camera apparatus 10. The bridge device 117 is realized, for example, by a USB controller.

The external device 20, as shown in FIG. 2, includes, in addition to the above-described CPU 21 and memory (main memory) 22, a bridge device 23, a graphics processing unit (GPU) 24, a display unit 25, an I/O controller 26, a hard disk drive (HDD) 27, a boot ROM 28 and a bridge device 29. The system configuration of the external device 20, which is shown in FIG. 2, is based on the assumption that the external device 20 is an information processing apparatus such as a personal computer.

The CPU 21 executes the operating system and various application programs, which are stored in the HDD 27. In the case where the operating system is booted from the HDD 114 in the camera apparatus 10, the CPU 21 executes the above-described second operating system (OS#B) and second image edit program (edit application #B) which are stored in the HDD 114.

The bridge device 23 connects a local bus of the CPU 21 and the I/O controller 26. In addition, the bridge device 23 is provided with a function of controlling communication with the GPU 24. The GPU 24 is a display controller having various image rendering process functions and various image process functions, and generates a video signal which forms a screen image that is to be displayed on the display unit 25. The display unit 25 is composed of, e.g. a liquid crystal display device (LCD), and is used as a display monitor of the external apparatus 20. The display screen size and display resolution of the display unit 25 are greater than the display screen size and display resolution of the display unit 116 of the camera apparatus 10.

A monitor program, such as a basic input/output system (BIOS), is stored in the boot ROM 28. The monitor program executes a process of booting the operating system from the HDD 27 in the external apparatus 20 or from the HDD 114 in the camera apparatus 10. The bridge device 29 executes communication with the camera device 10 via the cable 1 which is connected to an I/O connector 30 that is provided on the external apparatus 20. The bridge device 29 is realized, for example, by a USB controller.

Normally, in the external apparatus 20, the monitor program boots the operating system that is installed in the HDD 27. In the state in which the camera apparatus 10 is connected to the external apparatus 20 via the cable 1, the monitor program can boot the second operating system (OS#B) from the HDD 114 of the camera device 10 (external OS boot function). In order to boot the second operating system (OS#B) from the HDD 114 of the camera device 10, it is necessary to enable the external OS boot function in advance.

In the state in which the external OS boot function is enabled in advance by the user, the monitor program displays, in response to power-on of the external apparatus 20, a menu for prompting the user to designate one of the boot of the operating system from the HDD 27 and the boot of the operating system from the external boot device (HDD 114 of the camera device 10) on the display screen of the display unit 25. If the user selects the external boot device (HDD 114 of the camera device 10), the monitor program generates a read request which designates a predetermined address in an external I/O address space that is managed by the bridge device 29. This read request is a read request for reading the second operating system (OS#B) from the external boot device, and is sent to the camera apparatus 10 via the bridge device 29.

In the camera apparatus 10, the read request, which is sent from the external apparatus 20, is received by the bridge device 117. Upon receiving the read request, the bridge device 117 generates, for example, an interrupt signal to the CPU 111. In this case, the CPU 111 issues a DMA (direct memory access) transfer instruction to the data transfer process unit 15 in accordance with the read request that is received by the bridge device 117. Specifically, in accordance with the read request, the CPU 111 instructs the data transfer process unit 15 to execute read access to the HDD 114, and instructs the data transfer process unit 15 to execute two kinds of DMA transfers. One of the DMA transfers is DMA transfer from the HDD 114 to the memory 112, and the other DMA transfer is DMA transfer from the memory 112 to the bridge device 117. The data (OS#B), which is transferred to the bridge device 117 by the DMA transfer, is sent to the external apparatus 20 by the bridge device 117.

When the read request is received, the bridge device 117 may, instead of generating the interrupt signal to the CPU 111, transfer the received read request to the data transfer process unit 15 via the I/O bus. In this case, when the data transfer process unit 15 has received the read request from the bridge device 117, the data transfer process unit 15 generates the above-described interrupt signal to the CPU 111. Under the control of the CPU 111, the data transfer process unit 15 executes read access to the HDD 114 and the above-described two kinds of DMA transfers.

Since the second operating system (OS#B) is stored in a predetermined memory area in the HDD 114, there is no need to execute a process for searching the entire memory area of the HDD 114 for the second operating system (OS#B). Address information, which is indicative of the memory area that stores the second operating system (OS#B), may be stored in the external device 20 or in the camera apparatus 10. The above-described address information may be stored in a specific sector in the HDD 114. In this case, the monitor program is able to recognize the address of the memory area, in which the second operating system (OS#B) is stored, by referring to the address information of the specific sector.

In the external device 20, after the boot of the second operating system (OS#B) is completed, the second operating system (OS#B) automatically generates a read request for reading the second image edit program (edit application #B). This read request designates the address of a predetermined memory area in the HDD 114, where the second image edit program (edit application #B) is stored. This read request is sent to the camera apparatus 10 via the bridge device 29.

In the camera device 10, the data transfer process unit 15 executes the same procedure as described above for reading out the second operating system (OS#B) from the HDD 114. Thereby, the second image edit program (edit application #B) is read out of the HDD 114, and is transferred to the external apparatus 20 via the bridge device 117.

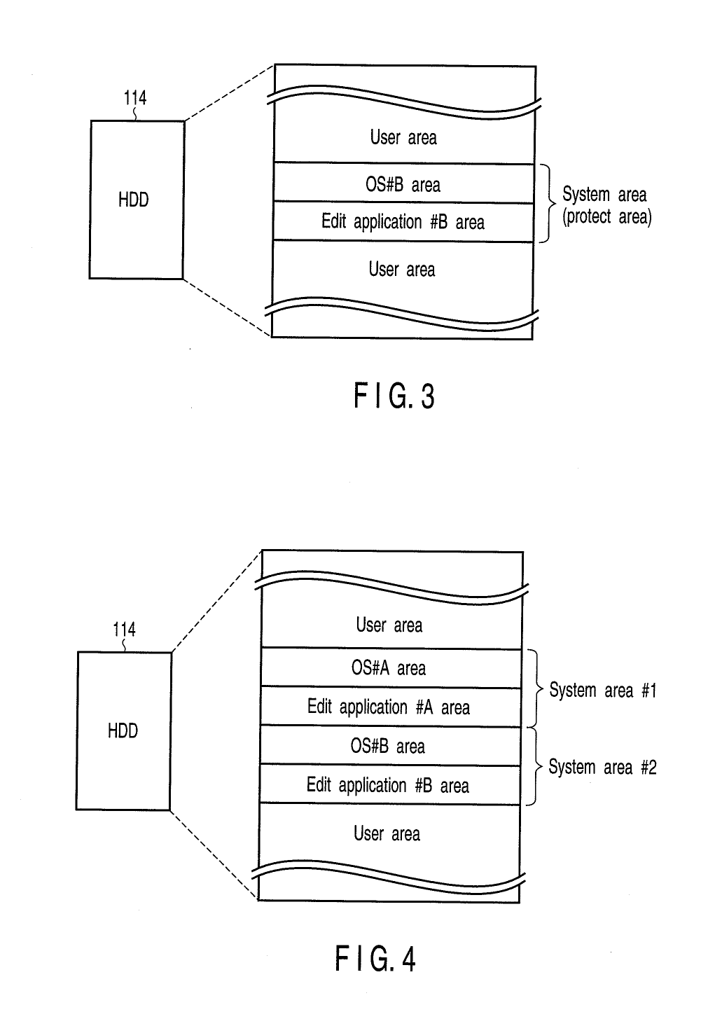

Next, referring to FIG. 3 and FIG. 4, a description is given of how the memory space of the HDD 114 is used.

FIG. 3 shows an example of memory area allocation corresponding to the case in which only the second operating system (OS#B) and second image edit program (edit application #B), which are to be loaded in the external device 20, are stored in the HDD 114. The first operating system (OS#A) and first image edit program (edit application #A) are stored in the nonvolatile memory 113.

The memory area of the HDD 114 is divided into a user area, an OS#B area and an edit application #B area. The user area is the above-described first memory area, and is used for storing, e.g. image data. The OS#B area is the above-described second memory area, and stores the second operating system (OS#B). The edit application #B area is the above-described third memory area, and stores the second image edit program (edit application #B). The OS#B area and the edit application #B area are write-protected. Specifically, each of the OS#B area and the edit application #B area is a protect area (system area) in which data write is prohibited.

FIG. 4 shows an example of memory area allocation corresponding to the case in which the first operating system (OS#A), the first image edit program (edit application #A), the second operating system (OS#B) and the second image edit program (edit application #B) are stored in the HDD 114.

The memory area of the HDD 114 is divided into a user area, an OS#A area, an edit application #A area, an OS#B area and an edit application #B area. The OS #A area stores the first operating system (OS#A). The edit application #A area stores the first image edit program (edit application #A). The OS#A area and the edit application #A area, like the OS#B area and the edit application #B area, are write-protected areas (system areas).

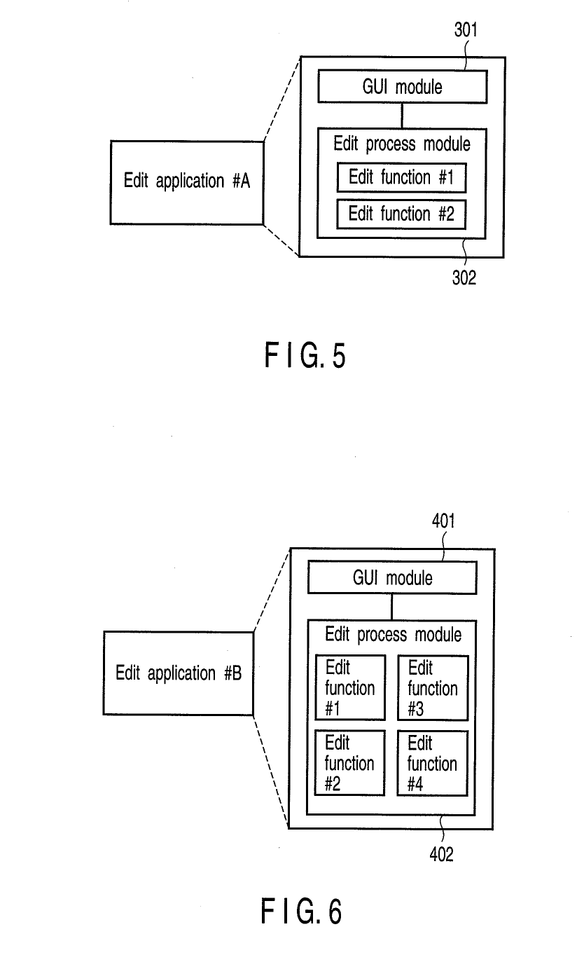

Next, referring to FIG. 5 and FIG. 6, a description is given of the functional structures of the first image edit program (edit application #A) and the second image edit program (edit application #B).

FIG. 5 shows the functional structure of the first image edit program (edit application #A). FIG. 6 shows the functional structure of the second image edit program (edit application #B).

The edit application #A is the application program which is executed by the camera apparatus 10, as described above, and includes a graphical user interface (GUI) module 301 and an edit process module 302.

The edit application #B is the application program which is executed by the external apparatus 20 having a higher performance than the camera apparatus 10, as described above. The edit application #B includes a graphical user interface (GUI) module 401 and an edit process module 402.

The design of the user interface for edit, which is displayed by the edit application #B, is the same as, or is equal to, the design of the user interface for edit, which is displayed by the edit application #A. In addition, the edit application #B has a higher level edit function than the edit application #A. In other words, the edit application #A has a specific first edit function, and the edit application #B has a second edit function in which the first edit function is expanded.

The GUI module 301 of the edit application #A displays an edit screen on the display unit 11 of the camera apparatus 10. Image data to be edited, or image data after edit is displayed on this edit screen. Further, this edit screen displays an edit menu showing, e.g. a list of executable edit functions. The names of the edit functions, which are displayed on the edit menu, are identical between the edit application #A and edit application #B.

The display screen size (display resolution) of the display unit 116 is relatively small. Accordingly, the size (display resolution) of the edit screen, which is displayed by the GUI module 301, is also relatively small.

On the other hand, since the display screen size (display resolution) of the display unit 25 of the external apparatus 20 is larger than the display screen size (display resolution) of the display unit 116, the GUI module 401 of the edit application #B displays an edit screen, which has a higher resolution than the edit screen that is displayed by the GUI module 301, on the display unit 25 of the external apparatus 20.

Image data to be edited or image data after edit is displayed with a high resolution on the edit screen that is displayed by the GUI module 401. In addition, it is possible to display, on the edit screen, not only image data of a to-be-edited scene, but also image data corresponding to some scenes preceding and following the to-be-edited scene. Besides, an operation panel including a plurality of edit buttons can be displayed on the edit screen.

The edit process module 302 of the edit application #A includes, for example, an edit function #1 and an edit function #2. The edit function #1 includes, for example, a chapter division function for dividing moving picture data into a plurality of chapters, and a cut function for deleting a part of the moving picture data. The edit function #2 includes, for example, an effect function such as fade-in/fade-out. The edit process module 402 of the edit application #B includes an edit function #3 and an edit function #4, in addition to the above-described edit function #1 and edit function #2. Each of the edit function #3 and the edit function #4 is an edit function for expanding the above-described chapter division function, cut function or effect function, respectively.

In addition, the edit process module 402 may subject the to-be-edited image data to different kinds of effect processes, thereby generating a plurality of kinds of provisionally edited image data and displaying a list of the provisionally edited image data on the edit screen. The user can determine the content of the effect process, which is to be finally used, from the list of the provisionally edited image data.

As has been described above, the two kinds of edit applications, which have the uniform user interface, are prestored in the camera apparatus 10. Thus, even in the case where the user performs the edit operation by using the external apparatus 20, the user can perform the edit operation with the same feeling as in the case of performing the edit operation by using only the camera apparatus 10. Moreover, since the edit screen, which is displayed on the display device of the external apparatus 20 is sufficiently large, the user can efficiently perform the edit operation without feeling stress.

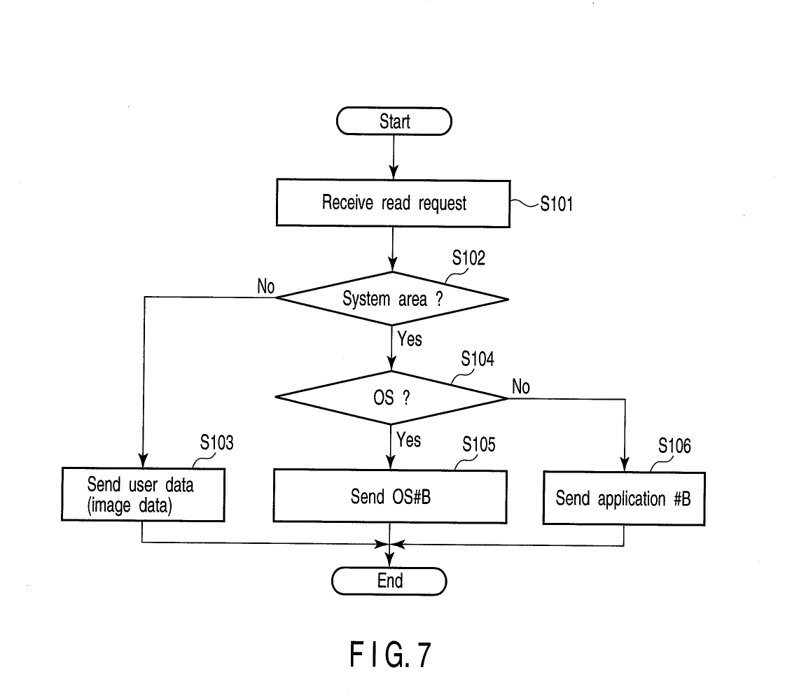

Next, referring to a flow chart of FIG. 7, the procedure of the data transfer process, which is executed by the camera apparatus 10, is described.

The camera apparatus 10 receives a read request which is sent from the external apparatus 20 via the cable 1 (step S101). As described above, the reception of the read request is executed by the bridge device 117. Responding to the reception of the read request by the bridge device 117, the CPU 111 and data transfer process unit 15 cooperate to execute the following data transfer process.

Specifically, the camera apparatus 10 determines whether a to-be-read area, which is designated by the address included in the received read request, is the system area or not (step S102). If the to-be-read area is not the system area, that is, if the to-be-read area is the user area (NO in step S102), the camera apparatus 10 reads out user data (image data) in the user area, which is designated by the address, from the HDD 114, and sends the user data (image data) to the external device 20 via the bridge device 117 (step S103).

If the to-be-read area is the system area (YES in step S102), the camera apparatus 10 determines whether the to-be-read area, which is designated by the address, is the OS#B area or not (step S104). If the to-be-read area, which is designated by the address, is the OS#B area (YES in step S104), the camera apparatus 10 reads out the data (OS#B) in the OS#B area, which is designated by the address, from the HDD 114, and sends the data (OS#B) to the external device 20 via the bridge device 117 (step S105).

If the to-be-read area, which is designated by the address, is not the OS#B area but the edit application #B area (NO in step S104), the camera apparatus 10 reads out the data (edit application #B) in the edit application #B area, which is designated by the address, from the HDD 114, and sends the data (edit application #B) to the external device 20 via the bridge device 117 (step S106).

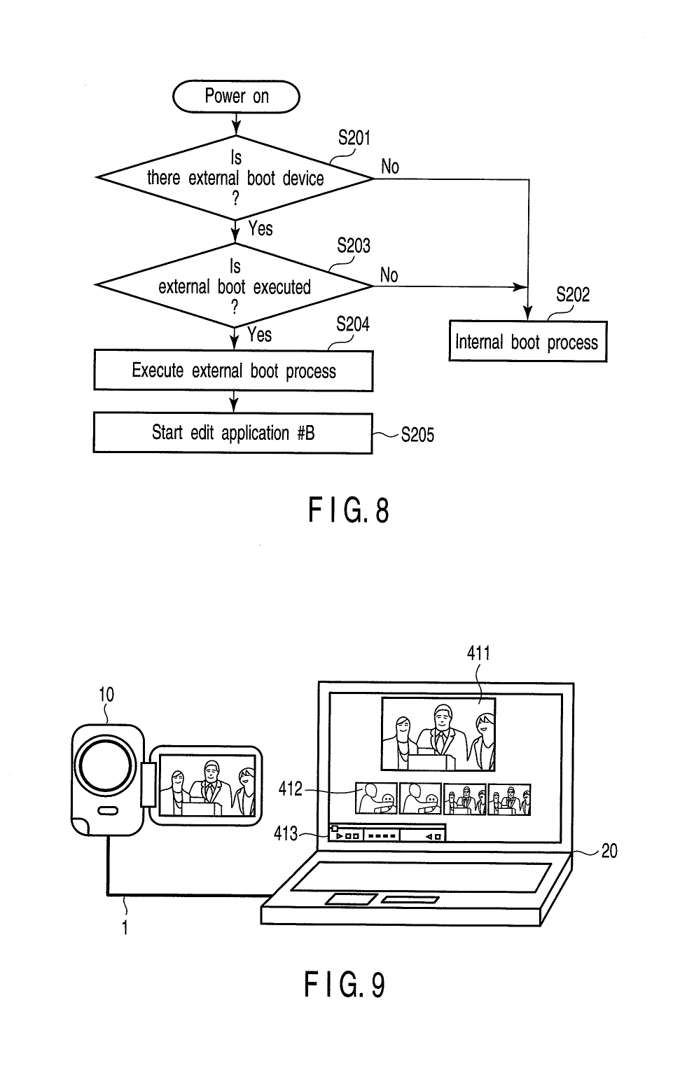

Next, referring to a flow chart of FIG. 8, the procedure of the boot process, which is executed by the external apparatus 20, is described.

When the external apparatus 20 is powered on, the CPU 21 of the external device 20 detects a boot device (also referred to as “bootable device”), and determines whether there is an external boot device which is connected to the external apparatus 20 (step S201). In the case where the camera apparatus 10 is connected to the external device 20, the HDD 114 of the camera apparatus 10 is detected as the external boot device.

If the external boot device is not detected (NO in step S201), the CPU 21 executes a process (internal boot process) of booting the operating system from an internal boot device (e.g. HDD 27 in the external apparatus 20) (step S202).

If the external boot device is detected (YES in step S201), the CPU 21 displays, on the display screen of the display unit 25, a menu which prompts the user to designate whether or not to execute the external boot process for booting the operating system from the detected external boot device. If the user designates the execution of the external boot process (YES in step S203), the CPU 21 executes the external boot process for booting the operating system (OS#B) from the OS#B area of the HDD 114 (step S204).

In step S204, the CPU 21 sends the read request, which designates the OS#B area of the HDD 114 as the to-be-read area, to the camera apparatus 10 via the bridge device 29. The CPU 21 loads in the memory 22 the operating system (OS#B) that is transferred from the camera apparatus 10, and boots the operating system (OS#B).

A code, which starts the image edit program (edit application #B) in the edit application #B area of the HDD 114 when the boot of the operating system (OS#B) is completed, is embedded in the operating system (OS#B). Thus, after the completion of the boot of the operating system (OS#B), the CPU 21, under the control of the operating system (OS#B), executes the process of starting the image edit program (edit application #B) in the edit application #B area of the HDD 114 (step S205). In step S205, the operating system (OS#B) sends the read request, which designates the edit application #B area of the HDD 114 as the to-be-read area, to the camera apparatus 10 via the bridge device 29. The operating system (OS#B) performs a process of loading in the memory 22 an execution file of the image edit program (edit application #B) that is transferred from the camera apparatus 10, and executes the image edit program (edit application #B).

In accordance with a user operation, the image edit program (edit application #B) reads out to-be-edited image data which is stored in the user area of the HDD 114, and executes an edit process on the to-be-edited image data. The edited image data is written in an empty area in the user area of the HDD 114 by the image edit program (edit application #B). Needless to say, the image edit program (edit application #B) can also write the edited image data in the HDD 27 in the external apparatus 20.

The operating system (OS#B) has only a minimum necessary function for executing the image edit process. Accordingly, the time that is needed for booting the operating system (OS#B) is much shorter than the time that is needed for booting the general-purpose operating system which is stored in the HDD 27 in the external apparatus 20. Further, the operating system (OS#B), in response to the completion of the boot thereof, automatically executes the image edit program (edit application #B) that is stored in the HDD 114. In this case, the operating system (OS#B) does not need to execute a device detection process for detecting whether the camera apparatus 10 is connected to the external apparatus 20. The reason for this is that the completion of the boot of the operating system (OS#B) means that the camera apparatus 10 is connected to the external apparatus 20.

Therefore, the user can immediately start the edit operation for editing the image data stored in the camera apparatus 10, simply by executing the operation of powering on the external apparatus 20 in the state in which the camera apparatus 10 is connected to the external apparatus 20.

FIG. 9 shows an example of the edit screen which is displayed on the display device of the external apparatus 20.

As has been described above, the user interface, which is displayed on the display device of the external apparatus 20, is similar to the user interface which is displayed on the display device of the camera apparatus 10 when the edit process is executed solely by the camera apparatus 10. Since the display screen of the display device of the external apparatus 20 is larger than the display screen of the display device of the camera apparatus 10, the edit screen which is displayed on the display device of the external apparatus 20 displays, in addition to a monitor area 411 for displaying pre-edit or post-edit image data, a thumbnail display area (also referred to as “time line”) for displaying still images corresponding to some scenes, and an operation panel 413 for prompting the user to instruct various edit and playback processes.

Since the image data after edit is written in the HDD 114 by the image edit program (edit application #B), the image data after edit may also be displayed on the display device of the camera apparatus 10, as shown in FIG. 9.

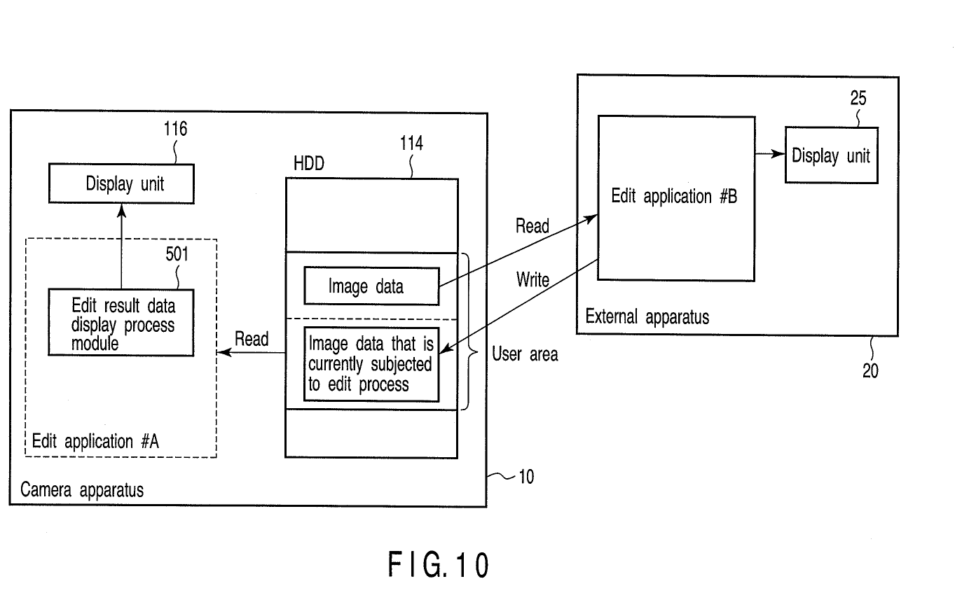

Next, referring to FIG. 10, a description is given of how the image data that is edited by the external apparatus 20 is displayed on the display device of the camera apparatus 10.

The image edit program (edit application #B) loaded in the external apparatus 20 reads the to-be-edited image data that is stored in the user area of the HDD 114, and executes the edit process on the image data. The edit application #B writes the edited image data (image data that is currently being edited) in an empty area in the user area of the HDD 114. In this case, the edit application #B sends a write request and the edited image data to the camera apparatus 10 via the operating system OS#B. In the camera apparatus 10, the CPU 111 controls the data transfer process unit 15 in accordance with the write request, and writes the image data, which is edited by the edit application #B, in an empty area in the user area of the HDD 114.

The edit application #A, which is executed by the camera apparatus 10, includes an edit result data display process module 501 as one of its functional modules. The edit result data display process module 501 reads out the edited image data from the user area of the HDD 114, and displays the edited image data on the display unit 116.

As described above, since the image data, which is currently being edited by the edit application #B, is the data that is stored in the HDD 114 in the camera apparatus 10, the image data, which is currently being edited, can be displayed on the display unit 116 of the camera apparatus 10.

Besides, a photographing operation may be executed by the camera apparatus 10 in the state in which the camera apparatus 10 is connected to the external apparatus 20, and the image data that is acquired by the photographing operation may be sent to the external apparatus 20 in real time, while being stored in the HDD 114 in the camera apparatus 10. In this case, the edit application #B can store the image data, which is sent in real time from the camera apparatus 10, in the HDD 27 of the external apparatus 20, while automatically executing, where necessary, such a process on the image data, as an effect process, a resolution conversion process, a frame rate conversion process or a transcode process.

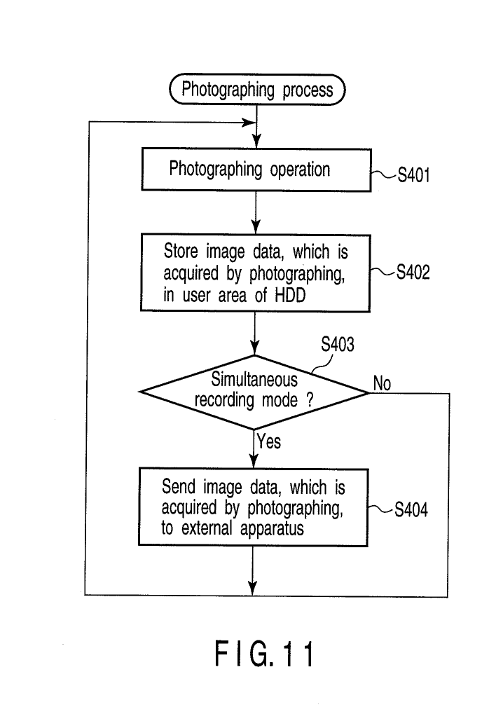

Next, referring to a flow chart of FIG. 11, a description is given of the procedure of a simultaneous recording process for storing the image data, which is acquired by the photographing operation, in the HDD 114 in the camera apparatus 10, while storing, at the same time, the image data in the HDD 27 of the external apparatus 20.

The CPU 111 of the camera apparatus 10 causes the camera unit 11 to start a photographing operation (step S401). The CPU 111 controls the data transfer process unit 15, and stores the image data, which is acquired by the camera unit 11, in the user area of the HDD 114 (step S402). In the case where the present operation mode is a simultaneous recording mode (YES in step S403), the CPU 111 controls the data transfer process unit 15 and bridge device 117, and also executes the process of sending to the external apparatus 20 the image data that is acquired by the camera unit 11 (step S404).

In the external apparatus 20, the edit application #B subjects, where necessary, the image data, which is sent from the camera apparatus 10, to predetermined processing, and stores the processed image data in the HDD 27 of the external apparatus 20.

As has been described above, in the present embodiment, the HDD 114 of the camera apparatus 10 stores the operating system (OS#B) for activating the external apparatus 20 and the image edit program (edit application #B) which runs on the operating system (OS#B). When the external apparatus 20 is powered on, the operating system (OS#B) and the image edit program (edit application #B) are loaded in the external apparatus 20 and executed.

Since the operating system (OS#B) may have only a minimum necessary function for realizing the environment in which the edit application #B is executable in the external apparatus 20, the operating system (OS#B) can quickly be booted.

Therefore, the edit of image data, which is stored in the camera apparatus 10, can immediately be started, without using a dedicated storage medium, by only the simple operation of connecting the camera apparatus 10 to the external apparatus 20 and powering on the external apparatus 20. The user does not need to purchase software for video edit and to install it in the external apparatus 20.

By making use of the image edit program (edit application #A) which is stored in the camera apparatus 10, the user can perform the edit operation solely by the camera apparatus 10, without connecting the camera apparatus 10 to the external apparatus 20.

In the case where a computer is started by using an operating system which is stored in a dedicated storage medium such as a CD-ROM, it is necessary to perform, after the operating system is booted, a device detection process for detecting whether a video apparatus (AV apparatus) is connected to the computer. By contrast, in the present embodiment, the external apparatus 20 is activated by using the operating system that is stored in the storage device in the camera apparatus 10, and the image data to be edited is stored in the storage device. Thus, there is no need to execute the device detection process for detecting the camera apparatus 10 after the operating system is booted. Therefore, since the device detection process after the boot of the operation system is needless, the time that is needed to activate the external apparatus 20 can be shortened.

In the present embodiment, the case in which the storage device provided in the camera apparatus 10 is the HDD has been exemplified. Alternatively, the storage device may be realized by, for instance, a semiconductor disk drive which incorporates a flash EEPROM.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera apparatus comprising:
an editing module configured to execute a first image editing program to edit image data captured by a camera module within the camera apparatus;
a storage device configured to store the image data, an operating system for activating an external apparatus, and a second image editing program configured to execute on the operating system; and
a data transfer module configured to transfer the operating system to the external apparatus upon a first read request from the external apparatus, and to transfer the second image editing program to the external apparatus upon a second read request, the second read request being sent from the operating system after the operating system is booted on the external apparatus.

2. The camera apparatus of claim 1, wherein the second image editing program is configured to display, on a display of the external apparatus, an editing screen having a higher resolution than an editing screen displayed by the first image editing program on a display of the camera apparatus.

3. The camera apparatus of claim 2, wherein the first image editing program is configured to execute a first image editing function and the second image editing program is configured to execute a second image editing function comprising the first image editing function.

4. The camera apparatus of claim 1, wherein the second image editing program is configured to write image data edited by the second image editing program in an empty area in the first memory area of the storage device, and
the camera apparatus further comprises an editing result data display process module configured to read out the edited image data from the first memory area and to display the edited image data on a display of the camera apparatus.

5. The camera apparatus of claim 1, wherein the storage device comprises a first memory area storing the image data, a second memory area storing the operating system, and a third memory area storing the second image editing program, the second memory area and the third memory area are protected areas where writing data is prohibited.

6. The camera apparatus of claim 1, wherein the storage device is a hard disk drive.

7. The camera apparatus of claim 1, further comprising a nonvolatile memory configured to store the first image editing program and an operating system configured to control an operation of the camera apparatus.

8. The camera apparatus of claim 1, wherein
the storage device comprises a first memory area storing the image data, a second memory area storing the operating system, and a third memory area storing the second image editing program; and
the first read request comprises a first address information specifying the second memory area, and the second read request comprises a second address information specifying the third memory area.

9. A method of controlling a camera apparatus comprising:
capturing an image data;
editing the captured image data with a first image editing program;
storing the image data in a first memory area of the storage device;
storing an operating system for an external apparatus in a second memory area of the storage device;
activating the external apparatus connected to the camera apparatus;
transferring the operating system to the external apparatus upon a first read request from the external apparatus;
transferring a second image editing program stored in a third memory area of the storage device to the external apparatus upon a second read request, the second read request being sent from the operating system after the operating system is booted on the external apparatus; and
running the second image editing program on the operating system.

10. The method of claim 9, further comprising:
writing the image data edited by the second image editing program, in an empty area in the first memory area of the storage device upon a write request sent from the second image editing program executed by the external apparatus;
reading out the edited image data from the first memory area; and
displaying the edited image data on a display of the camera apparatus.

11. The method of claim 9, further comprising:
displaying, on a display of the external apparatus, an editing screen having a higher resolution than an editing screen displayed by the first image editing program on a display of the camera apparatus.

12. The method of claim 9, wherein the first read request comprises address information specifying the second memory area, and the second read request comprises address information specifying the second memory area.
